(19) United States
(12) Patent Application Publication
(10) Pub. No.: US 2001/0021933 A1
(43) Pub. Date: Sep. 13, 2001

(54) Data processing system with file memory and data processing method

(76) Inventor: Takuo Kitamura, Gifu (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/800,710

(22) Filed: Mar. 7, 2001

(30) Foreign Application Priority Data
Mar. 9, 2000 (JP) 2000-064867

(51) Int. Cl. G06F 17/30

(52) U.S. Cl. 707/200

(57) ABSTRACT

Basic processes such as a document process, a calculation process, a communication process and a search process and operations are efficiently managed under unified file management so that various complicated processes can be handled additionally and in an expanded manner by a data processing system. Basic files of a centralized text format which allow each of physical files 142a, whose unique heading information is write time-of-day information thereof, to correspond to a plurality of logical files 142b can be operated in a unified manner on a plurality of screens displayed by switching of operation window 112. A file of any format can be annexed to each of the basic files, and operation window 112 provides means for allowing any program to be executed thereby to additionally provide the universality and the expandability to the data processing system.

### BACKGROUND OF THE INVENTION

1. Field of the Invention

This invention relates to a data processing system for a computer and data processing method, and more particularly to a data processing system with a file memory and data processing method.

2. Description of the Related Art

A conventional personal computer is used in a monopolized manner by an operator who changes over a program for each object of use and uses data of a file unique to the program with an operation screen changed over. FIG. 1 is a schematic block diagram of a typical personal computer.

Data processing apparatus (CPU) 930 takes charge of control of the entire system and arithmetic operation as a center of arithmetic operation and control. It is assumed now that an operator intends to use the personal computer of FIG. 1 to process three programs including a word processor program, a spreadsheet program and an electronic mail processing program, for example. Word processor program P1 941a, spreadsheet program P2 941b and electronic mail processing program P3 941c are stored in internal memory 941. A file corresponding to program P1 941a is stored as file F1 942a, another program corresponding to program P2 941b as file F2 942b and a further program corresponding to program P3 941c as file F3 942c in different formats in file memory 942.

When the operator uses any of the programs, the operator changes over operation window 912 to a window of the program and operates on operation window 912. Man-machine interface 911 includes a screen display, a key input and a mouse input necessary for the operation. Interfacing with inputting/outputting apparatus and communication lines is processed by external apparatus interface 913. Since the personal computer as well is a kind of computer for universal use, it is possible to prepare a program wherein file F1 942a, file F2 942b and file F3 942c are unified into a database system and program P1 941a, program P2 941b and program P3 941c access the common database. This, however, complicates preparation of the program and use and operation of the system. Therefore, a program of the type described is not prepared for an ordinary object of personal use.

As described above, a conventional personal computer is disadvantageous in that it is used in a monopolized manner by an operator who changes over a program for each object of use and uses data of a file unique to the program with an operation screen changed over and that data of files unique to the individual programs cannot be used commonly by the programs.

### SUMMARY OF THE INVENTION

It is an object of the present invention to provide a system which is easy to use in that data can be used commonly in a unit of a file among programs which are used very frequently for an object of personal use such as a document handling program, a spreadsheet program and an electronic mail program and can be expanded with appropriate complication for a more complicated object of use. More specifically, it is an object of the present invention to provide a system and a method wherein files unique to programs such as file F1 942a, file F2 942b and file F3 942c of FIG. 1 can be used commonly and simply by the individual programs and can be operated on operation windows suitable for the individual programs while such universality and expandability as of conventional computers are maintained.

According to an aspect of the present invention, there is provided a data processing system with a file memory which includes an inputting and outputting apparatus having a man-machine interface, an operation window and an external apparatus interface, a storage apparatus having an internal memory and a file memory, and a data processing apparatus, characterized in that the data processing apparatus includes a data processing mechanism for performing arithmetic operation and control, and a file access mechanism, that the file memory stores physical files each having heading information which is information of an order in which the physical files are written into the file memory and logical files each having heading information which is an arbitrary character string, that each of the physical files can correspond to plural ones of the logical files and that each of the physical files can be accessed by the file access mechanism based on any of the heading information of the physical file and the heading information of the logical file or files corresponding to the physical file.

Preferably, the heading information of the physical files is information of times of day at which the physical files are written. The heading information of each of the logical files may have number information n added thereto for identifying the corresponding physical file. Contents of the physical files may have the text format, and a plurality of files of any format can be annexed as annexed files to each of the physical files. Part of the heading information of the logical files may form classification information, and the classification information can be used to access the classified logical files.

Preferably, the operation of the operation window includes at least one of a document processing operation, a calculation processing operation, a communication processing operation and a search processing operation. A described macro command may be stored in the file memory, and execution of the described macro command can be designated on the operation window.

According to another aspect of the present invention, there is provided a data processing method, characterized in that it comprises the steps of switching an operation window to a desired operation screen through a man-machine interface to designate the object of an operation, accessing one of physical files and logical files of a file memory through a file access mechanism in response to a state of the operation window and an instruction of the man-machine interface, causing a data processing mechanism to perform common arithmetic operation and control in response to the state of the operation window and the instruction of the man-machine interface, and determining, when a new version of the physical file or a new physical file is to be produced, the order in which the physical file is written as heading information of the physical file.

Preferably, when a new version of the physical file or a new physical file is to be produced, information of time of day at which the physical file is written is determined as heading information. Each of the logical files may be accessed based on classification information in the heading information of the physical file.

Preferably, the operation screen of the operation window is switched for one of a document processing operation, a calculation processing operation, a communication processing operation and a web network search processing operation. A command of designating execution on the operation window may be execution of a described macro command stored in the file memory.

The above and other objects, features, and advantages of the present invention will become apparent from the following descriptions based on the accompanying drawings which illustrate an example of a preferred embodiment of the present invention.

### BRIEF DESCRIPTION OF THE DRAWINGS

FIG. 1 is a schematic block diagram of a typical personal computer;

FIG. 2 is a schematic block diagram of a data processing apparatus of an embodiment of the present invention;

FIG. 3 is an explanatory view of data of a physical file stored in a file memory of FIG. 2;

FIG. 4 is an explanatory view of access information of the physical file stored in the file memory of FIG. 2;

FIG. 5 is a schematic view of a screen display of a window in a document operation state;

FIG. 6 is a schematic view of a screen display of a window in a calculation operation state;

FIG. 7 is a schematic view of a screen display of a window in a communication operation state;

FIG. 8 is a schematic view of a screen display of a window in a search operation state; and

FIG. 9 is a schematic view of a screen display of a window in a macro operation state.

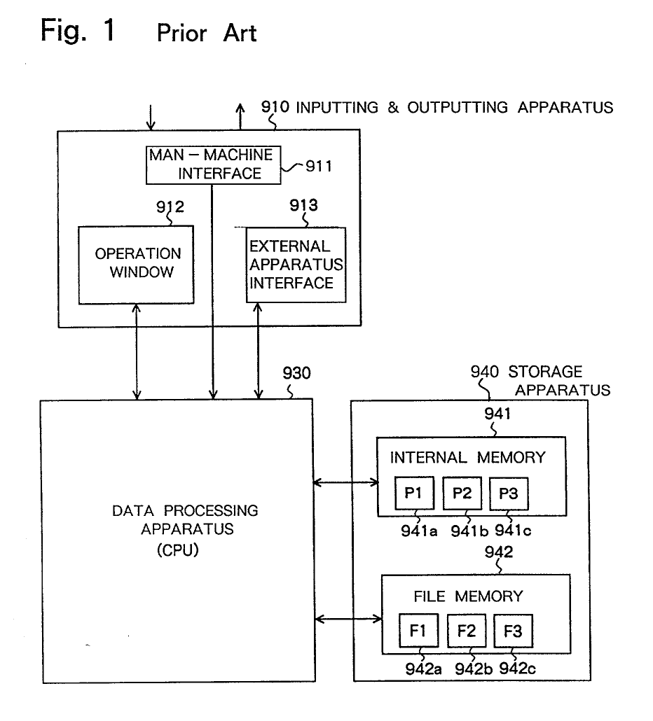

### DETAILED DESCRIPTION OF THE PREFERRED EMBODIMENT

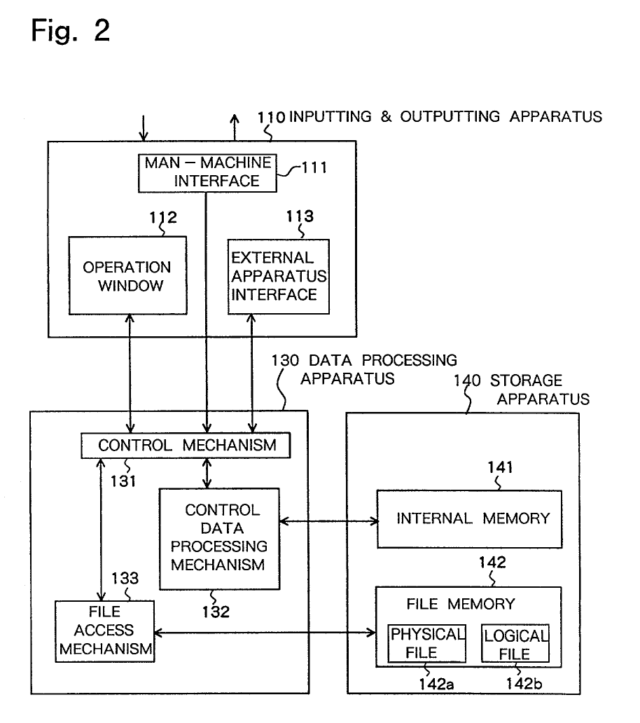

Next, an embodiment of the present invention will be described with reference to the drawings. FIG. 2 is a schematic block diagram of a personal computer provided with a data processing apparatus of the embodiment of the present invention. File memory 142 is storage means for storing contents of files and typically includes a disk storage apparatus and control means for the disk storage apparatus. File access mechanism 133 provides means for accessing the files in file memory 142. Operation window 112 includes a display screen for displaying information necessary for an operator to operate the personal computer. Man-machine interface 111 is a connection mechanism for man-machine interface information from a keyboard and a mouse operated by the operator. File access mechanism 133 accesses file memory 142 in response to an instruction of the operator from operation window 112 or man-machine interface 111. Control data processing mechanism 132 performs arithmetic operation control or arithmetic operation and control of a particular operation program in response to an instruction of the operator from operation window 112 and man-machine interface 111. Internal memory 141 stores commands and work data necessary for arithmetic operation and control of a program. External apparatus interface 113 is a connection mechanism to inputting/outputting apparatus and communication lines.

Each of physical files 142a stored in file memory 142 of FIG. 2 includes such data as illustrated in FIG. 3. q1 represents an address at which the preceding physical file is stored. q2 represents an address at which the succeeding physical file is stored. t indicates the year, month, day and time of day of the Christian era at which the file is stored in a unit of millisecond for distinction from the other files. The same t is prevented from corresponding to different files and therefore serves as unique heading information of the physical file. All files of the physical file can be accessed by tracing pairs of the pointer information of q1 and q2. The order in which the files can be traced with the pointers is the order of storage time of day, i.e., the order of t. While it is described here that the year, month, day and time of day at which the file is stored are indicated in a unit of millisecond with t for distinction from the other files, any other means may be used if it indicates the order in which files are written.

ps represents page information. Each file can be delimited into pages. s represents the total number of pages, and p represents the position of the page in the total page number s. When p is 0, it indicates that the file is not delimited into pages. vt represents version information. v represents the version of the file, and a new version is represented with an ascending order number. t paired with v represents t of the preceding version, i.e., the heading information of the preceding version. Contents of the file regarding all versions can be acquired by tracing the information of paired v and t. #xn represents heading information of a logical file. Heading information of a single logical file or a plurality of logical files corresponding to each physical file can be applied to the physical file. # is a classification part of a logical file and is composed of a plurality of arbitrary symbols, numerals and/or characters. x is a heading part of a classified logical file and is composed of a plurality of arbitrary symbols, numerals and/or characters. n is a number for identification where the same heading information is applied to different pieces of physical information. #xn generally makes up heading information of one logical file. ind represents the number of annexed files. Where ind is 0, this signifies that no annexed file is involved. h represents a header, and where header information is not input, a top portion of contents of the file is automatically placed in an overlapping relationship in the header h. y represents contents of the file and is stored in the text format. index represents a single annexed file or a plurality of annexed files.

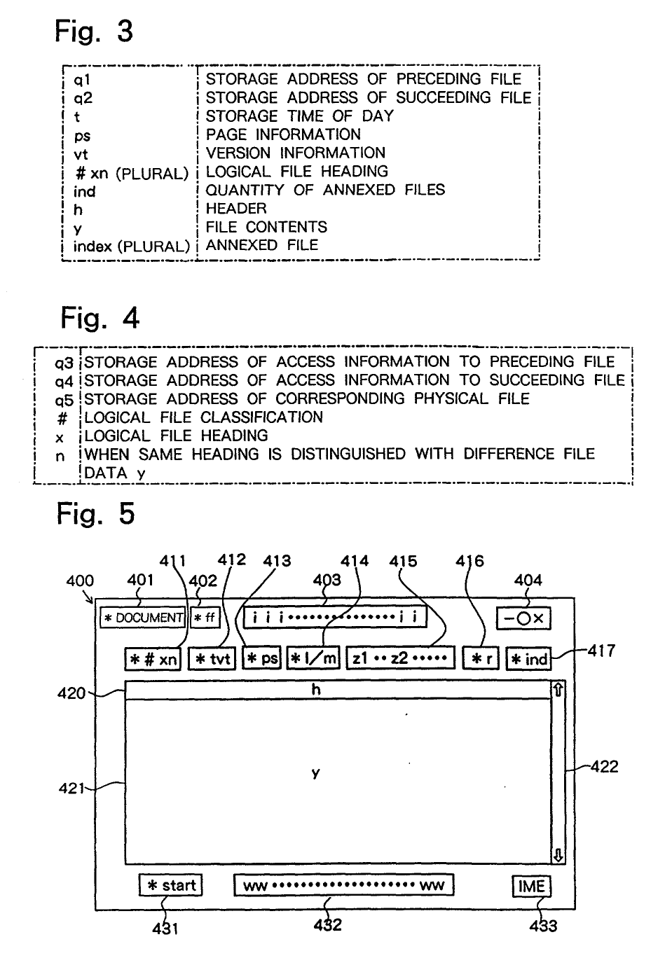

Information of logical files 142b illustrated in FIG. 4 is stored in file memory 142 of FIG. 2. q3 represents a storage address of information of the preceding logical file. q4 represents a storage address of the succeeding logical file. q5 represents an address in which a physical file corresponding to the logical file is stored. #xn generally represents heading information of the logical file as described above. The heading #xn can be traced with q3 or q4 as described above and is arrayed in a descending or ascending order of codes given to the symbols, numerals and/or characters thereof.

Address information q₁₁ of one of physical files 142a which has been accessed latest and address information q₁₂ of one of logical files 142b which has been accessed latest are stored in file access mechanism 133 of FIG. 2. When heading information t of a physical file to be accessed is given (only top portion information of heading information t may be given) to file access mechanism 133, file access mechanism 133 traces physical files, which have the configuration of FIG. 3, in a descending order or an ascending order beginning with address q₁₁ until it accesses a physical file having heading information t which coincides with t. If top portion information of t is given, that one of files having partially coincident t which has the oldest time of day is accessed. If the year, month and day are given as t, for example, then that one of files coincident in terms of the year, month and day which has the oldest storage time is accessed. If t is not given but heading information #xn of a logical file is given as information to be accessed, then the access information of logical files of FIG. 4 is traced in a descending order or an ascending order beginning with address information q₁₂ until a logical file having coincident #xn is found, and a pertaining physical file stored in address q5 of the logical file is accessed.

Operation window 112 of FIG. 2 has four principal states including a document operation state, a calculation operation state, a communication operation state and a search operation state. FIG. 5 shows a screen display 400 of the operation window in the document operation state. Contents of the screen display always display a state to which the screen corresponds, and the operator can perform an operation of an intended apparatus while observing the screen display. Displays and operations of the windows comply with displays and operations of windows on an ordinary personal computer. The document operation can prepare a document in the standard text format and store the document into file memory 142 of FIG. 2. The document operation can otherwise read out a document stored in file memory 142 of FIG. 2, and refer to, rewrite and store the document. [*] and [Document] are displayed in region 401. The [*] display indicates that, if the location where [*] is displayed is clicked with the mouse (in the following description, the term “click” is used to signify that a location is clicked by an operation of the mouse), then a relating display appears to display necessary information and allow a selective operation. If such selection is performed, then the display disappears. If [*] in region 401 is clicked, then displays of [Document], [Calculation], [Communication] and [Search] appear successively, and if one of the displays is clicked, then the current document operation state is interrupted and the pertaining window is switchably displayed. A type of a command represented by a [*] display and a character string [ff] is displayed in region 402. If * is clicked, then types of command which can be executed in the document operation state are displayed and one of the types can be selected and displayed in region 402. The types of command include readout, overlapping readout, write, search, header search, full text search, deletion and macro although contents of the commands will be hereinafter described. Hieroglyphic displays representative of types of operation called icon are arrayed in region 403. Each i in region 403 indicates a type of icon operation used in the document window. If one of the icons is clicked, then a corresponding operation is performed. The operations include an instruction to execute a command displayed in region 402, for example, and an instruction to execute a command used frequently such as [readout] or [write], for example. In region 404, symbol displays [−α×] are displayed. If [−] is clicked, then the entire screen display of the window of the document operation state is reduced and the operation is interrupted. If [◯] is clicked, then the entire screen display is expanded. If [×] is clicked, then the document operation state is ended.

A [*] display and heading information of a logical file can be displayed in region 411. A [*] display and heading information t and version information vt of the physical file can be displayed in region 412. A [*] display and page information ps are displayed in region 413. Any information can be input from the keyboard into regions 411, 412 and 413 except the [*] displays. If the command [readout], for example, is executed, then a file displayed in regions 411, 412 and 413 is read out. If only heading information t of the physical file is displayed, then the physical file t is read out and the heading of one of corresponding logical files is displayed in region 411. In this reading out of the physical file, if the heading information t which coincides with designated t is not found, then the oldest one of the physical files which exhibit coincidence at a top portion of t is read out. If the year, month and day, for example, are given, then the oldest physical file which exhibits coincidence in terms of the year, month and day is read out, but if a file which exhibits coincidence in terms of the day is not found, then the oldest file which exhibits coincidence in terms of the year and month is read out.

If a heading information t is designated and a logical file #xn is designated, then a physical file corresponding to the logical file under the condition that conditions designated by the physical file are satisfied is read out. If a physical file is not designated but only a logical file is designated, then a physical file corresponding to the logical file is read out. If files designated with #xn do not include a file which does not exhibit coincidence in terms of n or else n is not designated by #xn, then a physical file corresponding to #x0 is read out. The number of logical files corresponding to the physical file read out is displayed at r of region 416. If a physical file corresponding to #x is not found out, then r of region 416 is displayed as 0.

If a physical file is read out, then heading information t, version information vt and page information ps of the physical file are displayed in regions 412 and 413. Similarly, header information h, file contents y, logical file number r and index number ind are displayed in 410, 421, 416 and 417, respectively. If [*] in region 411 is left-clicked after the file is read out, then headings and headers of a plurality of logical files #xn in an ascending order are displayed in pairs, and such headings and headers can be scrolled by keeping [*] depressed. Similarly, the logical files #xn can be displayed in a descending order by right-clicking of [*]. One of the displayed logical files can be read out by double clicking the logical file. At this time, the displays in regions 411, 412 and 413 are changed to those of the pertaining file. Such clicking and double clicking operations are effective similarly to region 412 as well.

Information relating to the command [Search] is displayed in region 414 and region 415. A [*] display and r are displayed in region 416. r represents the number of logical files corresponding to the physical file whose heading is displayed in region 412. If [*] is clicked, then all of the headings of the corresponding logical files are displayed. If one of the displayed logical files is double-clicked, then the file can be read out. At this time, the displays in regions 411, 412 and 413 are changed to those of the pertaining file.

Information relating to annexed files is displayed in region 417. The number of accompanying files is displayed with ind. If [*] is clocked, then the numbers of all annexed files and an indication of whether or not the files are stored in the text format are displayed. If one of the files is double-clicked, then contents of the file are read out. However, for any accompanying file which is not stored in the text format, only binary data is displayed in region 417.

The header h and contents y corresponding to a physical file tvtps or a logical file #xn are displayed in region 420 and region 421, respectively. In regions 420 and 421, characters can be input from the keyboard to prepare, modify and edit a document in the standard text format.

A scrolling function is displayed in region 422, and the contents of y can be scrolled by continuously clicking ↑ or ↓. If a page display on which contents are displayed is set to y displayed as a result of scrolling, the page display p in region 413 is changed to the page display corresponding to y thus displayed as a result of scrolling.

*Start is displayed in region 431. If [*] is clicked, then alternation of initialization conditions of the apparatus, starting of execution of a particular program and so forth are displayed to allow selective instruction of one of the displayed items by clicking it.

A display of an operation station during interruption and a particular program being interrupted are displayed in a shaded form in region 432, and the program can be re-started by clicking the display or the program. The re-started state is displayed brightly, and can be interrupted again if it is clicked again. w displays such operation states or the name of the program. A control state regarding document handling of the Japanese language similar to that of a personal computer called IME is displayed in region 433.

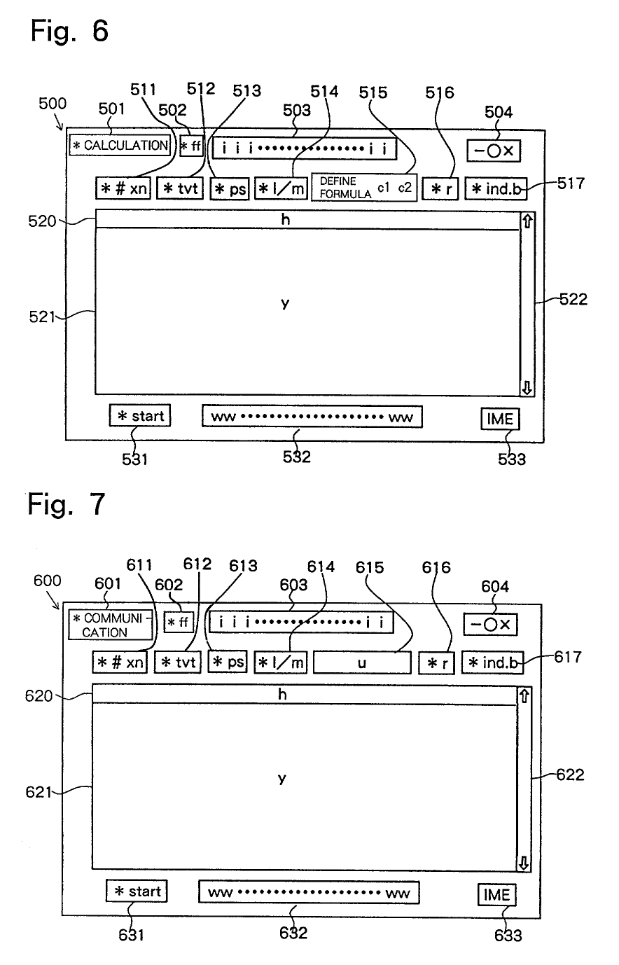

FIG. 6 shows screen display 500 of a window in the calculation operation state. In the calculation operation, it is possible to perform an operation which involves calculation for an arbitrary file through a screen operation, store a result of the calculation into a file if necessary and modify the result of calculation in the stored file. [*] and [Calculation] are displayed in region 501. If [*] in region 501 is clicked, then displays of [Document], [Calculation], [Communication] and [Search] appear, and if one of the displays is selectively clicked, then the current operation is interrupted and the pertaining window is switchably displayed. A type of a command is displayed with a [*] display and the two characters [ff] in region 502. Such commands as readout, overlapping readout, write, deletion, macro and calculation are available although contents of the commands will be hereinafter described. If * is clicked, then types of commands which can be executed in the calculation operation state are displayed, and one of the commands can be selected and displayed in region 502. Hieroglyphic displays representative of types of operations called icon are arrayed in region 503. Each i in region 503 indicates a type of icon operation used in the communication window. If one of the icons is clicked, then a corresponding operation is performed. Displays and operations relating to regions 504, 511, 512, 513, 514, 516, 517, 520, 521, 522, 531, 532 and 533 are similar to those relating to regions 404, 411, 412, 413, 414, 416, 417, 420, 421, 422, 431, 432 and 433 of FIG. 5, respectively.

A definition expression, parameters c1, c2 and so forth when the [Calculation] command is executed are displayed in region 515. Such definition expression, parameters c1, c2 and so forth can be input into region 515 from the keyboard.

FIG. 7 shows screen display 600 of a window in the communication operation state. In the communication operation, operation relating to an electronic mail is performed, and sending or receiving of an electronic mail is performed to or from an arbitrary file. An electronic mail is utilized also as principal means for transfer of data to and from the outside of the apparatus. The data format is not limited to the text format, and data of any format including multi-media data can be handled by using a function of an accompanying file. [*] and [Communication] are displayed in region 601. If [*] in region 601 is clicked, then displays of [Document], [Calculation], [Communication] and [Search] appear, and if one of the displays is selectively clicked, then the current operation state is interrupted and the pertaining window is switchably displayed. A type of a command is displayed with a [*] display and the two characters [ff] in region 602. Such commands as readout, overlapping readout, write, deletion, macro and calculation are available although contents of the commands will be hereinafter described. If * is clicked, then types of commands which can be executed in the calculation operation state are displayed, and one of the commands can be selected and displayed in region 602. Hieroglyphic displays representative of types of operations called icon are arrayed in region 603. Each i in region 603 indicates a type of icon operation used in the communication window. If one of the icons is clicked, then a corresponding operation is performed. Displays and operations relating to regions 604, 611, 612, 613, 614, 616, 617, 620, 621, 622, 631, 632 and 633 are similar to those relating to regions 404, 411, 412, 413, 414, 416, 417, 420, 421, 422, 431, 432 and 433 of FIG. 5, respectively.

A URP address u for an electronic mail when a command relating to [Communication] is executed is displayed in region 615. u can be input into region 615 from the keyboard as well.

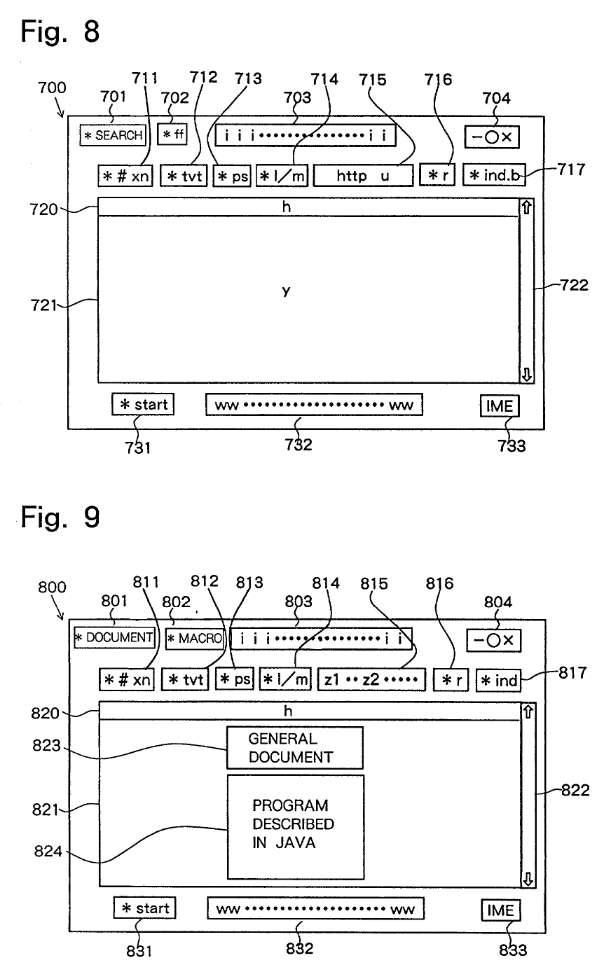

FIG. 8 shows screen display 700 of a window in the web network search operation state. In the search operation, operation relating to search for a homepage is performed, and the homepage searched out is displayed on the screen. Further, when necessary, information of the displayed screen can be annexed as an annexed file to a basic file and can be arranged, managed and stored orderly. Therefore, the screen of the homepage searched out can be reproducibly displayed. [*] and [Search] are displayed in region 701. If [*] in region 701 is clicked, then displays of [Document], [Calculation], [Communication] and [Search] appear, and if one of the displays is selectively clicked, then the current operation state is interrupted and the pertaining window is switchably displayed. A type of a command is displayed with a [*] display and the two characters [ff] in region 702. Such commands as readout, overlapping readout, write, deletion, macro and calculation are available although contents of the commands will be hereinafter described. If * is clicked, then types of commands which can be executed in the search operation state are displayed, and one of the commands can be selected and displayed in region 702. Hieroglyphic displays representative of types of operations called icon are arrayed in region 703. Each i in region 703 indicates a type of icon operation used in the search window. If one of the icons is clicked, then a corresponding icon operation is performed. Displays and operations relating to regions 704, 711, 712, 713, 714, 716, 717, 720, 721, 722, 731, 732 and 733 are similar to those relating to regions 404, 411, 412, 413, 414, 416, 417, 420, 421, 422, 431, 432 and 433 of FIG. 5, respectively.

When a command relating to [Search] is executed, an http address u of a homepage is displayed in region 715. u can be input into region 715 from the keyboard as well.

Next, operations of the commands executed in the operation windows will be described. In the document operation window, the following commands can be executed.

1) Readout

File contents y are read out into region 421 in accordance with a designation of regions 411, 412 and 413 of FIG. 5.

2) Overlapping Readout

File contents y are read out into region 421 in accordance with a designation of regions 411, 412 and 413 in an overlapping relationship with contents currently displayed in region 421. This command allows two documents to be edited and united readily.

3) Write

Contents y of region 412 are written in one of the following write modes into a file of file memory 142 of FIG. 2 designated with regions 411, 412 and 413. Such five write modes as given below are available.

Before an actual writing operation is performed, a pertaining mode is selected in accordance with a displayed instruction. Where the contents of region 420 are the space, a designated number of top characters of y in region 421 are automatically written as h in an overlapping relationship into region 420. At this time, a symbol string [---] is written at the last of the character string.

(1) Overwrite

An existing file designated by regions 411, 412 and 413 is read out, and contents of the file are replaced with the header h and the contents y in regions 420 and 421 and written back into the original file. The heading information t is maintained as it is.

(2) New Preparation

An existing file designated by regions 411, 412 and 413 is not present, and a new file configuration of FIG. 3 is prepared at a predetermined position on a pointer chain of q1 and q2 of FIG. 3 and written as a new file into file memory 142 of FIG. 2.

(3) New Version Production

Although an existing file designated by regions 411, 412 and 413 is present, contents y of region 412 are prepared as a new version while the existing file is left. At this time, the version of FIG. 3 is incremented by 1 to produce vt. The new heading of the physical file is the time t upon writing.

(4) Distinguished preparation of logical file n

When #x in region 411 coincides with existing files but is distinguished with n from a corresponding physical file y, the maximum value of n of the existing files is incremented by 1 to produce new n thereby to produce new #xn and a new file of #xn is produced and written.

(5) Preparation of United Physical File With Logical File Without Being Distinguished

#x in region 411 coincides with some of existing files, and file contents y are united with one of the coincident files. The existing file is selected by clicking [*] in region 411, and the contents y of region 421 are united following the contents y of the existing file to produce contents y of a new file thereby to produce a new file configuration of FIG. 3 from the contents y of the new file. The new file configuration is written into a predetermined position.

4) File Search

Those of logical file headings within a range designated with [#] of region 411 or [t] of region 412 which satisfy a condition of region 415 are searched for. When [#] is the space, files of all classifications are regarded as an object of the search. [t] designates those files of the year, month, day and time of day within the designated range as an object of the search. The conditions of [#] and [t] are regarded as a logically ANDed condition. z1. . . z2 in region 415 designates a search for logical files x which each coincides at the top thereof with the character string z1 and further coincides with the character string z2 following don't care next to the character string z1. The number of files which satisfy the condition is indicated by m in region 414. The heading of one of the coincident files is displayed in regions 411 and 412. If [*] in region 414 is clicked, then 1 in region 414 increases and the heading of a corresponding file is displayed in regions 411 and 412. [*] in region 411 or region 412 can be clicked to check the headings and the headers of the files preceding and following the displayed file in order.

5) Header Search

A character string which coincides with a condition of region 415 from among the headers of files within a range designated with [#] of region 411 or [t] of region 412 is searched for.

When [#] is the space, the headers of files of all classifications are considered as an object of the search.

[t] designates those files of the year, month, day and time of day within the designated range as an object of the search.

The conditions of [#] and [t] are regarded as a logically ANDed condition. z1. . . z2 . . . in region 415 designates a search for headers h which each coincides at the top thereof with the character string z1 and further coincides with the character string z2 following don't care next to the character string z1. The number of character strings which satisfy the condition is indicated by m in region 414. Contents of a file in which the coincident character string is included are read out as y into region 421, and the coincident character string is displayed in a shaded form. The heading of the file corresponding to the contents y is displayed in regions 411 and 412. If [*] in region 414 is clicked, then 1 in region 414 increases and the heading, the header and contents of a corresponding file are displayed in regions 411, 412, 420 and 421. [*] in region 411 or region 412 can be clicked to check the headings and the headers of the files preceding and following the displayed file in order.

6) Full Text Search

A character string which coincides with a condition of region 415 from file contents y within a range designated with [#] of region 411 or [t] of region 412. When [#] is the space, the headers of files of all classifications are considered as an object of the search. [t] designates those files of the year, month, day and time of day within the designated range as an object of the search. The conditions of [#] and [t] are regarded as a logically ANDed condition. z1. . . z2 . . . in region 415 designates a search for a character string which coincides at the top thereof with the character string z1 and further coincides with the character string z2 following don't care next to the character string z1. The number of character strings which satisfy the condition is indicated by m in region 414. Contents of a file in which the coincident character string is included are read out as y into region 421, and the coincident character string is displayed in a shaded form. The heading of the file corresponding to the contents y is displayed in regions 411 and 412. If [*] of region 414 is clicked, then 1 in region 414 increases and the heading, the header and contents of a corresponding file are displayed in regions 411, 412, 420 and 421. [*] in region 411 or region 412 can be clicked to check the headings and the headers of the files preceding and following the displayed file in order.

7) Deletion

A pertaining file designated with #xnt, tvt, ps is deleted. When necessary, automatic deletion or correction of relating data is performed.

8) Macro

The macro command is designated with #xnt. Also by clicking [*] in region 431 of FIG. 5, it is possible to select the macro command and set #xnt for designation of the macro command to #xnt regions 411 and 412.

The macro command designates execution of a program designated in advance. An example is shown in FIG. 9. In region 823, a general document of an object, an outline and so forth regarding the program is described. In region 824, the program described in the JAVA language is indicated. The program is executed in accordance with the description of the interpreter type. In region 824, a command which does not directly relate to execution of the program and all of a procedure, subroutine calls, parameters and so forth necessary for execution of the program are described. While the described contents in region 821 are handled in a similar manner as an ordinary text file and can be corrected and edited, they are executed in accordance with a predetermined program as the macro command.

The following commands can be executed in calculation screen display 500 of FIG. 6.

1) Readout: same as that in the document operation window.

2) Overlapping readout: same as that in the document operation window.

3) Write: same as that in the document operation window.

4) Deletion: same as that in the document operation window.

5) Macro: same as that in the document operation window.

6) Calculation

Calculation or spreadsheet operation is executed in a region y in accordance with a definition expression and parameters in region 515. A manner of operation can be selected with an icon i.

The following commands can be executed in communication screen display 600 of FIG. 7.

1) Readout: same as that in the document operation window.

2) Overlapping readout: same as that in the document operation window.

3) Write: same as that in the document operation window.

4) Deletion: same as that in the document operation window.

5) Macro: same as that in the document operation window.

6) Sending/receiving

A mail is sent or received. The type of the operation can be selected with an icon i.

The following commands can be executed in the web network search screen display 700 of FIG. 8.

1) Readout: same as that in the document operation window.

2) Overlapping readout: same as that in the document operation window.

3) Write: same as that in the document operation window.

4) Deletion: same as that in the document operation window.

5) Macro: same as that in the document operation window.

6) Search

A homepage is searched for. The type of the operation can be selected with an icon i.

Next, editing functions and frame displaying functions common to all operation windows will be described.

1) Editing

The editing function is designated with an icon and includes copying of a character string displayed on the screen of an operation window and dragged with the mouse as is performed on a standard personal computer into a working memory, deletion of such a character string and pasting of a copied character string to a location designated with the cursor.

2) Frame Displaying

The frame displaying function allows storage of frame information [such information as is, as it were, printed in advance on paper] common to files of the # classification in an address whose logical file # is the space and displays the frame information normally in an overlapping relationship when y is displayed. The frame information is used only upon displaying and is not stored in the individual files.

In order to store the frame information into contents of the individual files, it is necessary to process the frame information with the command [Overlapping readout] and write the overlapped contents.

As described above, the data processing system according to the embodiment of the present invention can process data universally over a wide range similarly to an ordinary personal computer if various programs are prepared in the form of a macro command in addition to basic processing functions in operation windows. However, different characteristics and a common manner of use of the data processing system different from those of a standard personal computer will be described below.

In a standard personal computer, a program set or group to be used for a particular application is selected and installed into the personal computer under an OS. Then, the OS is started up in order to allow actual use of the program set. In other words, a manner of use for a particular object of use must be selected from within the universality of a wide range. In contrast, the data processing system of the embodiment of the present invention makes the functions and operations of document, calculation, communication and search, which are basic procedures of use, common as far as possible so that it can be used immediately under unified file management without specifically performing selection, installation and startup of a program. A necessary macro command function can be added to the basic function just described in accordance with an individual object.

More specifically, the data processing system of the embodiment of the present invention is used characteristically in the following manner.

1) Document

All memos and records are automatically stored as physical files at points of time at which they are written in order of time. If necessary, arbitrary heading information may be applied for classification to a file so that the file may be managed as a logical file. Since the same physical file can correspond to a plurality of logical files, a single entity data can correspond to a plurality of different classifications or files. A single set of the minutes of proceedings, for example, can be classified for individual themes or for individual issuing sections. Meanwhile, use of the function of adding n to a physical file #x allows many different physical files to be cited by the same logical file #x, and if heading information of a logical file is regarded as a kind of index information, then an arbitrary index can be applied to any physical file or entity file. This classification allows application of re-arrangement and re-classification of files including deletion of a file at any time when necessary. Furthermore, since the heading information of a physical file is time-of-day information, files are automatically arranged with the time-of-day information and can therefore be searched with the time information. Although any header can be assigned to a file, even if no header is assigned to a file, a default process is performed for the file. A search range and a search condition can be selected for the header or contents of a file to search for files which satisfy the condition, and this can be utilized typically for research of a document, editing of a document and arrangement of documents. A basic file is a standard text file and allows addition thereto of a plurality of annexed files of arbitrary formats. Any annexed file which is not a standard text file is processed individually with the macro command of an additional function.

2) Calculation

The data processing system can perform calculation and spreadsheet operation for a basic file in the calculation window.

3) Communication

The data processing system can transfer a document file in the form of an electronic mail. While mail can be temporarily stored into a stack, they may otherwise be classified, arranged and managed in a centralized fashion as document files. A document file can be transferred in the form of an annexed file to a basic file of a document to or from the outside and can be stored into the inside of the data processing system.

4) Search in the Network

The data processing system can search for a homepage in a similar manner as in a standard personal computer and can store contents of a necessary page in the form of an annexed file with a comment in the format of a basic file added thereto so that it can re-utilize the stored contents when necessary.

5) Expanded Function

The data processing system can have universality similar to that of a standard personal computer by preparing a program in the form of a macro command. Described contents of the macro command can be read, written or operated otherwise similarly to a document file.

It is to be noted that the present invention can be carried out in various forms in addition to the embodiment described above and may be carried out such that it includes a CPU, a main storage apparatus, an inputting and outputting apparatus, a magnetic disk apparatus and a controller, which form a personal computer, as hardware and the functions of the present invention are simulated with software which operates on the CPU and the main storage apparatus.

As described above, the present invention has the following advantages.

First, all input data are automatically stored as basic files in order of the writing time, and the writing times of the basic files serve as unique headings of physical files. This eliminates the necessity to intentionally input unique headings and allows automatic unified file management, and allows search for a file to be performed with an index for which the time of day, which is definite commonly to all people is used.

Second, since physical files to each of which a unique heading is applied with the time of day are classified and arranged with logical files, the same physical file can be classified and arranged readily as a plurality of different logical files, and this makes search for a file convenient. A single set of the minutes of proceedings, for example, can be classified and arranged as documents for different projects or as documents for different sections.

Third, since a logical file can be further designated and distinguished with n, by utilizing logical file heading information as index information, one piece of heading information can be applied to many physical files, i.e., many entity files.

Fourth, since files managed in a unified manner can be accessed commonly through different operation windows, additional operations involved in movement or conversion of a file can be reduced.

Fifth, a basic file can be stored as a text file which allows easy full text search or basic character string processing while various data files including binary data can be stored as annexed files to achieve both efficient data processing and expandability.

Sixth, basic processes which are used frequently can be performed through unified operation windows having many common portions whereas an additional complicated process when necessary can be performed individually with a macro command which is a universal program process.

Seventh, files themselves which describe contents of a macro command can be managed in a unified manner in the form of basic files and can be accessed, modified and managed freely by an operator.

Eighth, since arrangement and storage of electronic mail can be performed commonly and pluralistically without distinction from document files, arrangement of documents and arrangement of electronic mail can be performed efficiently.

Ninth, a page searched out from a homepage can be stored as an annexed file, and arbitrary heading information can be stored in the text format of a basic file as a cited file of the accompanying file so that contents of the page can be searched out and re-utilized with the search command, and this makes utilization of the homepage efficient.

It is to be understood, however, that although the characteristics and advantages of the present invention have been set forth in the foregoing description, the disclosure is illustrative only, and changes may be made in the arrangement of the parts within the scope of the appended claims.

What is claimed is:

1. A data processing system with a file memory which includes an inputting and outputting apparatus having a man-machine interface, an operation window and an external apparatus interface, a storage apparatus having an internal memory and a file memory, and a data processing apparatus, characterized in that
said data processing apparatus includes a data processing mechanism for performing arithmetic operation and control, and a file access mechanism, that
said file memory stores physical files each having heading information which is information of an order in which the physical files are written into said file memory and logical files each having heading information which is an arbitrary character string, that
each of the physical files can correspond to plural ones of the logical files; and that
each of the physical files can be accessed by said file access mechanism based on any of the heading information of the physical file and the heading information of the logical file or files corresponding to the physical file.

2. A data processing system according to claim 1, wherein the heading information of the physical files is information of times of day at which the physical files are written.

3. A data processing system according to claim 1, wherein the heading information of each of the logical files has number information n added thereto for identifying the corresponding physical file.

4. A data processing system according to claim 1, wherein contents of the physical files have the text format, and a plurality of files of any format can be annexed as annexed files to each of the physical files.

5. A data processing system according to claim 1, wherein part of the heading information of the logical files forms classification information, and the classification information can be used to access the classified logical files.

6. A data processing system according to claim 1, wherein operation contents of said operation window include at least one of a document processing operation, a calculation processing operation, a communication processing operation and a web network search processing operation.

7. A data processing system according to claim 1, wherein a described macro command is stored in said file memory, and execution of the described macro command can be designated on said operation window.

8. A data processing method, characterized in that it comprises the steps of:
switching an operation window to a desired operation screen through a man-machine interface to designate contents of an operation;
accessing one of physical files and logical files of a file memory through a file access mechanism in response to a state of said operation window and an instruction of said man-machine interface;
causing a data processing mechanism to perform common arithmetic operation and control in response to the state of said operation window and the instruction of said man-machine interface; and
determining, when a new version of the physical file or a new physical file is to be produced, the order in which the physical file is written as heading information of the physical file.

9. A data processing method according to claim 8, wherein, when a new version of the physical file or a new physical file is to be produced, information of time of day at which the physical file is written is determined as heading information.

10. A data processing method according to claim 8, wherein each of the logical files is accessed based on classification information in the heading information of the logical file.

11. A data processing method according to claim 8, wherein the operation screen of said operation window is switched for one of a document processing operation, a calculation processing operation, a communication processing operation and a web network search processing operation.

12. A data processing method according to claim 8, wherein a command of designating execution on said operation window is execution of a described macro command stored in said file memory.
